(19) United States
(12) Patent Application Publication
(10) Pub. No.: US 2007/0142603 A1
(43) Pub. Date: Jun. 21, 2007

(54) Polyurethane(urea) and sulfur-containing polyurethane(urea) and methods of preparation

(76) Inventor: Thomas G. Rukavina, New Kensington, PA (US)

Correspondence Address: PPG Industries, Inc.;Law Department, One PPG Place - 39th Floor, Pittsburgh, PA, 15272-0001, US

(21) Appl. No.: 11/303,670

(22) Filed: Dec. 16, 2005

(51) Int. Cl. C08G 18/00

(52) U.S. Cl. 528/44

(57) ABSTRACT

The present invention relates to polyurethane(urea) and sulfur-containing polyurethane(urea), and methods of their preparation. In a non-limiting embodiment, polyisocyanate, polyisothiocyanate or mixtures thereof can be reacted with polyol, polythiol or mixtures thereof, amine, and diol, dithiol or mixtures thereof to produce polyurethane(urea) and/or sulfur-containing polyurethane(urea).

The present invention relates to polyurethane(urea) and sulfur-containing polyurethane(urea), and methods for their preparation.

A number of organic polymeric materials, such as plastics, have been developed as alternatives and replacements for glass in applications such as optical lenses, fiber optics, windows and automotive, nautical and aviation transparencies. These polymeric materials can provide advantages relative to glass, including, shatter resistance, lighter weight for a given application, ease of molding and ease of dying. However, some high impact strength materials have poor solvent resistance and poor weatherability.

Thus, there is a need in the art to develop a polymeric material having high impact, high K factor, good solvent resistance and good weatherability.

For the purposes of this specification, unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

In the present invention, polyurethane(urea) can be produced by combining isocyanate; polyol; amine or a mixture of amine and polyol; and diol. Sulfur-containing polyurethane(urea) of the present invention can be produced by combining isocyanate and/or isothiocyanate; polyol and/or polythiol; amine or a mixture of amine and polyol and/or polythiol; and dithiol or a mixture of dithiol and diol.

As used herein and the claims, the terms “isocyanate” and “isothiocyanate” include unblocked compounds capable of forming a covalent bond with a reactive group such as thiol, hydroxyl, or amine functional group. In alternate non-limiting embodiments, the isocyanate of the present invention can contain at least one or at least two functional groups chosen from isocyanate (NCO), the isothiocyanate can contain at least one or at least two functional groups chosen from isothiocyanate (NCS), and the isocyanate and isothiocyanate materials can each include combinations of isocyanate and isothiocyanate functional groups.

In a non-limiting embodiment, isocyanate and/or isothiocyanate, polyol and/or polythiol; amine or a mixture of amine and polyol and/or polythiol; and diol or a mixture of diol and dithiol, can be reacted together in a one-pot process to form polyurethane(urea)/sulfur-containing polyurethane(urea).

In another non-limiting embodiment, isocyanate and/or isothiocyanate and polyol and/or polythiol can be reacted to form polyurethane prepolymer; the polyurethane prepolymer can be reacted with amine to form polyurethane polyurea isocyanate prepolymer; and the polyurethane polyurea isocyanate prepolymer can be reacted with diol or a mixture of diol and dithiol to form polyurethane/sulfur-containing polyurethane(urea). In this embodiment wherein prepolymer is formed, the amount of isocyanate and polyol in the reaction mixture can be such that the equivalent ratio of isocyanate to polyol (NCO:OH) is from 5.0:1.0 to 10.0:1.0. Further, the amine can be present such that it constitutes from 3 to 20% by weight based on the isocyanate in the mixture.

Isocyanates for use in the preparation of the polyurethane(urea) of the present invention are numerous and widely varied, and can include monomeric and polymeric isocyanate materials. Further, isothiocyanates useful in the preparation of sulfur-containing polyurethane(urea) are numerous and widely varied, and can include monomeric and polymeric isothiocyanate materials.

Suitable isocyanates for use in the present invention can include but are not limited to monomeric or polymeric isocyanates; aliphatic linear isocyanates; aliphatic branched isocyanates; cycloaliphatic isocyanates wherein one or more of the isocyanato groups are attached directly to the cycloaliphatic ring and cycloaliphatic isocyanates wherein one or more of the isocyanato groups are not attached directly to the cycloaliphatic ring; and aromatic isocyanates wherein one or more of the isocyanato groups are attached directly to the aromatic ring, and aromatic isocyanates wherein one or more of the isocyanato groups are not attached directly to the aromatic ring.

Suitable isothiocyanates for use in the present invention can include but are not limited to monomeric or polymeric isothiocyanates; aliphatic linear isothiocyanates; aliphatic branched isothiocyanates; cycloaliphatic isothiocyanates wherein one or more of the isocyanato groups are attached directly to the cycloaliphatic ring and cycloaliphatic isothiocyanates wherein one or more of the isocyanato groups are not attached directly to the cycloaliphatic ring; and aromatic isothiocyanates wherein one or more of the isocyanato groups are attached directly to the aromatic ring, and aromatic isothiocyanates wherein one or more of the isocyanato groups are not attached directly to the aromatic ring.

Non-limiting examples can include isocyanates and isothiocyanates having backbone linkages chosen from urethane linkages (—NH—C(O)—O—), thiourethane linkages (—NH—C(O)—S—), thiocarbamate linkages (—NH—C(S)—O—), dithiourethane linkages (—NH—C(S)—S—), polyamide linkages, and combinations thereof.

The molecular weight of the isocyanate and isothiocyanate can vary widely. In alternate non-limiting embodiments, the number average molecular weight (Mn) of each can be at least 100 grams/mole, or at least 150 grams/mole, or less than 15,000 grams/mole, or less than 5,000 grams/mole. The number average molecular weight can be determined using known methods. The number average molecular weight values recited herein and the claims were determined by gel permeation chromatography (GPC) using polystyrene standards.

Non-limiting examples of suitable isocyanates and isothiocyanates can include but are not limited to polyisocyanates having at least two isocyanate groups; polyisothiocyanates having at least two isothiocyanate groups; mixtures thereof; and combinations thereof, such as a material having both isocyanate and isothiocyanate functionality.

In a non-limiting embodiment, when using an aromatic polyisocyanate and/or polyisothiocyanate, general care should be taken to select material that does not cause the resulting polyurethane to color (e.g., yellow).

In a non-limiting embodiment of the present invention, the isocyanate can include but is not limited to aliphatic or cycloaliphatic diisocyanates, aromatic diisocyanates, cyclic dimmers and cyclic trimers thereof, and mixtures thereof. Non-limiting examples of suitable isocyanates can include but are not limited to Desmodur N 3300 (hexamethylene diisocyanate trimer) which is commercially available from Bayer; Desmodur N 3400 (60% hexamethylene diisocyanate dimer and 40% hexamethylene diisocyanate trimer).

In a non-limiting embodiment, the isocyanate can include dicyclohexylmethane diisocyanate and isomeric mixtures thereof. As used herein and the claims, the term “isomeric mixtures” refers to a mixture of the cis-cis, trans-trans, and cis-trans isomers of the polyisocyanate. Non-limiting examples of isomeric mixtures for use in the present invention can include the trans-trans isomer of 4,4′-methylenebis(cyclohexyl isocyanate), hereinafter referred to as “PICM” (paraisocyanato cyclohexylmethane), the cis-trans isomer of PICM, the cis-cis isomer of PICM, and mixtures thereof.

In one non-limiting embodiment, three suitable isomers of 4,4′-methylenebis(cyclohexyl isocyanate) for use in the present invention are shown below.

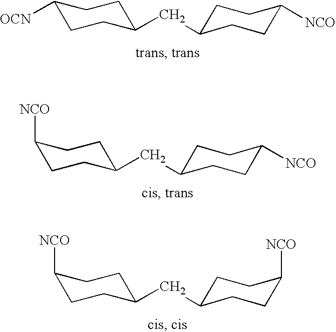

In one non-limiting embodiment, the PICM used in this invention can be prepared by phosgenating the 4,4′-methylenebis(cyclohexyl amine) (PACM) by procedures well known in the art such as the procedures disclosed in U.S. Pat. Nos. 2,644,007 and 2,680,127 which are incorporated herein by reference. The PACM isomer mixtures, upon phosgenation, can produce PICM in a liquid phase, a partially liquid phase, or a solid phase at room temperature. The PACM isomer mixtures can be obtained by the hydrogenation of methylenedianiline and/or by fractional crystallization of PACM isomer mixtures in the presence of water and alcohols such as methanol and ethanol.

In a non-limiting embodiment, the isomeric mixture can contain from 10-100 percent of the trans, trans isomer of 4,4′-methylenebis(cyclohexyl isocyanate)(PICM).

Additional aliphatic and cycloaliphatic diisocyanates that can be used in alternate non-limiting embodiments of the present invention include trimethylhexane diisocyanate, 3-isocyanato-methyl-3,5,5-trimethyl cyclohexyl-isocyanate (“IPDI”) which is commercially available from Arco Chemical, and meta-tetramethylxylene diisocyanate (1,3-bis(1-isocyanato-1-methylethyl)-benzene) which is commercially available from Cytec Industries Inc. under the tradename TMXDI™. (Meta) Aliphatic Isocyanate.

As used herein and the claims, the terms aliphatic and cycloaliphatic diisocyanates refer to 6 to 100 carbon atoms linked in a straight chain or cyclized having two diisocyanate reactive end groups. In a non-limiting embodiment of the present invention, the aliphatic and cycloaliphatic diisocyanates for use in the present invention can include TMXDI and compounds of the formula R— (NCO)₂ wherein R represents an aliphatic group or a cycloaliphatic group.

Further non-limiting examples of suitable isocyanates can include but are not limited to ethylenically unsaturated isocyanates; aliphatic isocyanates containing sulfide linkages; aromatic isocyanates containing sulfide or disulfide linkages; aromatic isocyanates containing sulfone linkages; sulfonic ester-type isocyanates, e.g., 4-methyl-3-isocyanatobenzenesulfonyl-4′-isocyanato-phenol ester; aromatic sulfonic amide-type isocyanates; sulfur-containing heterocyclic isocyanates, e.g., thiophene-2,5-diisocyanate; halogenated, alkylated, alkoxylated, nitrated, carbodiimide modified, urea modified and biuret modified derivatives of isocyanates thereof; and dimerized and trimerized products of isocyanates thereof.

In a further non-limiting embodiment, a sulfur-containing polyisocyanate of the following general formula (I) can be used: 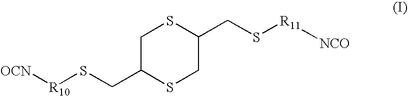
wherein R₁₀ and R₁₁ are each independently C₁ to C₃ alkyl.

Further non-limiting examples of aliphatic isocyanates can include ethylene diisocyanate, trimethylene diisocyanate, tetramethylene diisocyanate, hexamethylene diisocyanate, octamethylene diisocyanate, nonamethylene diisocyanate, 2,2′-dimethylpentane diisocyanate, 2,2,4-trimethylhexane diisocyanate, decamethylene diisocyanate, 2,4,4,-trimethylhexamethylene diisocyanate, 1,6,11-undecanetriisocyanate, 1,3,6-hexamethylene triisocyanate, 1,8-diisocyanato-4-(isocyanatomethyl)octane, 2,5,7-trimethyl-1,8-diisocyanato-5-(isocyanatomethyl)octane, bis(isocyanatoethyl)-carbonate, bis(isocyanatoethyl)ether, 2-isocyanatopropyl-2,6-diisocyanatohexanoate, lysinediisocyanate methyl ester and lysinetriisocyanate methyl ester.

Examples of ethylenically unsaturated polyisocyanates can include but are not limited to butene diisocyanate and 1,3-butadiene-1,4-diisocyanate. Alicyclic polyisocyanates can include but are not limited to isophorone diisocyanate, cyclohexane diisocyanate, methylcyclohexane diisocyanate, bis(isocyanatomethyl) cyclohexane, bis(isocyanatocyclohexyl)methane, bis(isocyanatocyclohexyl)-2,2-propane, bis(isocyanatocyclohexyl)-1,2-ethane, 2-isocyanatomethyl-3-(3-isocyanatopropyl)-5-isocyanatomethyl-bicyclo[2.2.1]-heptane, 2-isocyanatomethyl-3-(3-isocyanatopropyl)-6-isocyanatomethyl-bicyclo[2.2.1]-heptane, 2-isocyanatomethyl-2-(3-isocyanatopropyl)-5-isocyanatomethyl-bicyclo[2.2.1]-heptane, 2-isocyanatomethyl-2-(3-isocyanatopropyl)-6-isocyanatomethyl-bicyclo[2.2.1]-heptane, 2-isocyanatomethyl-3-(3-isocyanatopropyl)-6-(2-isocyanatoethyl)-bicyclo[2.2.1]-heptane, 2-isocyanatomethyl-2-(3-isocyanatopropyl)-5-(2-isocyanatoethyl)-bicyclo[2.2.1]-heptane and 2-isocyanatomethyl-2-(3-isocyanatopropyl)-6-(2-isocyanatoethyl)-bicyclo[2.2.1]-heptane.

Examples of aromatic polyisocyanates wherein the isocyanate groups are not bonded directly to the aromatic ring can include but are not limited to α,α′-xylene diisocyanate, bis(isocyanatoethyl)benzene, α,α,α′,α′-tetramethylxylene diisocyanate, 1,3-bis(1-isocyanato-1-methylethyl)benzene, bis(isocyanatobutyl)benzene, bis(isocyanatomethyl)naphthalene, bis(isocyanatomethyl)diphenyl ether, bis(isocyanatoethyl)phthalate, mesitylene triisocyanate and 2,5-di(isocyanatomethyl)furan. Aromatic polyisocyanates having isocyanate groups bonded directly to the aromatic ring can include but are not limited to phenylene diisocyanate, ethylphenylene diisocyanate, dimethylphenylene diisocyanate, diethylphenylene diisocyanate, diisopropylphenylene diisocyanate, trimethylbenzene triisocyanate, benzene diisocyanate, benzene triisocyanate, naphthalene diisocyanate, methylnaphthalene diisocyanate, biphenyl diisocyanate, ortho-toluidine diisocyanate, ortho-tolylidine diisocyanate, ortho-tolylene diisocyanate, 4,4′-diphenylmethane diisocyanate, bis(3-methyl-4-isocyanatophenyl)methane, bis(isocyanatophenyl)ethylene, 3,3′-dimethoxy-biphenyl-4,4′-diisocyanate, triphenylmethane triisocyanate, polymeric 4,4′-diphenylmethane diisocyanate, naphthalene triisocyanate, diphenylmethane-2,4,4′-triisocyanate, 4-methyldiphenylmethane-3,5,2′,4′,6′-pentaisocyanate, diphenylether diisocyanate, bis(isocyanatophenylether)ethyleneglycol, bis(isocyanatophenylether)-1,3-propyleneglycol, benzophenone diisocyanate, carbazole diisocyanate, ethylcarbazole diisocyanate and dichlorocarbazole diisocyanate.

Further non-limiting examples of aliphatic and cycloaliphatic diisocyanates that can be used in the present invention include 3-isocyanato-methyl-3,5,5-trimethyl cyclohexyl-isocyanate (“IPDI”) which is commercially available from Arco Chemical, and meta-tetramethylxylene diisocyanate (1,3-bis(1-isocyanato-1-methylethyl)-benzene) which is commercially available from Cytec Industries Inc. under the tradename TMXDI™. (Meta) Aliphatic Isocyanate.

In a non-limiting embodiment of the present invention, the aliphatic and cycloaliphatic diisocyanates for use in the present invention can include TMXDI and compounds of the formula R— (NCO)₂ wherein R represents an aliphatic group or a cycloaliphatic group.

Non-limiting examples of isocyanates can include aliphatic polyisocyanates containing sulfide linkages such as thiodiethyl diisocyanate, thiodipropyl diisocyanate, dithiodihexyl diisocyanate, dimethylsulfone diisocyanate, dithiodimethyl diisocyanate, dithiodiethyl diisocyanate, dithiodipropyl diisocyanate and dicyclohexylsulfide-4,4′-diisocyanate. Non-limiting examples of aromatic polyisocyanates containing sulfide or disulfide linkages include but are not limited to diphenylsulfide-2,4′-diisocyanate, diphenylsulfide-4,4′-diisocyanate, 3,3′-dimethoxy-4,4′-diisocyanatodibenzyl thioether, bis(4-isocyanatomethylbenzene)-sulfide, diphenyldisulfide-4,4′-diisocyanate, 2,2′-dimethyldiphenyldisulfide-5,5′-diisocyanate, 3,3′-dimethyldiphenyldisulfide-5,5′-diisocyanate, 3,3′-dimethyldiphenyldisulfide-6,6′-diisocyanate, 4,4′-dimethyldiphenyldisulfide-5,5′-diisocyanate, 3,3′-dimethoxydiphenyldisulfide-4,4′-diisocyanate and 4,4′-dimethoxydiphenyldisulfide-3,3′-diisocyanate.

Non-limiting examples of isocyanates can include aromatic isocyanates containing sulfone linkages such as diphenylsulfone-4,4′-diisocyanate, diphenylsulfone-3,3′-diisocyanate, benzidinesulfone-4,4′-diisocyanate, diphenylmethanesulfone-4,4′-diisocyanate, 4-methyldiphenylmethanesulfone-2,4′-diisocyanate, 4,4′-dimethoxydiphenylsulfone-3,3′-diisocyanate, 3,3′-dimethoxy-4,4′-diisocyanatodibenzylsulfone, 4,4′-dimethyldiphenylsulfone-3,3′-diisocyanate, 4,4′-di-tert-butyl-diphenylsulfone-3,3′-diisocyanate and 4,4′-dichlorodiphenylsulfone-3,3′-diisocyanate.

Non-limiting examples of aromatic sulfonic amide-type polyisocyanates for use in the present invention can include 4-methyl-3-isocyanato-benzene-sulfonylanilide-3′-methyl-4′-isocyanate, dibenzenesulfonyl-ethylenediamine-4,4′-diisocyanate, 4,4′-methoxybenzenesulfonyl-ethylenediamine-3,3′-diisocyanate and 4-methyl-3-isocyanato-benzene-sulfonylanilide-4-ethyl-3′-isocyanate. In alternate non-limiting embodiments, the isothiocyanate for use in the present invention can include but is not limited to cyclohexane diisothiocyanates; aromatic isothiocyanates wherein the isothiocyanate group(s) are not bonded directly to the aromatic ring; aromatic isothiocyanates wherein the isothiocyanate group(s) are bonded directly to the aromatic ring; heterocyclic isothiocyanates; carbonyl polyisothiocyanates; aliphatic polyisothiocyanates containing sulfide linkages; and mixtures thereof.

In a non-limiting embodiment, the isothiocyanate can be dithio-octane bis diol or thio-diethanol.

Non-limiting examples of materials having isocyanate and isothiocyanate groups can include materials having aliphatic, alicyclic, aromatic or heterocyclic groups and which optionally can contain sulfur atoms in addition to those of the isothiocyanate groups. Non-limiting examples of such materials can include but are not limited to 1-isocyanato-3-isothiocyanatopropane, 1-isocyanato-5-isothiocyanatopentane, 1-isocyanato-6-isothiocyanatohexane, isocyanatocarbonyl isothiocyanate, 1-isocyanato-4-isothiocyanatocyclohexane, 1-isocyanato-4-isothiocyanatobenzene, 4-methyl-3-isocyanato-1-isothiocyanatobenzene, 2-isocyanato-4,6-diisothiocyanato-1,3,5-triazine, 4-isocyanato-4′-isothiocyanato-diphenyl sulfide and 2-isocyanato-2′-isothiocyanatodiethyl disulfide.

In general, isocyanate and/or isothiocyanate can be reacted with active hydrogen-containing material to form polyurethane prepolymer. Active hydrogen-containing materials are varied and known in the art. Non-limiting examples can include hydroxyl-containing materials such as but not limited to polyols; sulfur-containing materials such as but not limited to hydroxyl functional polysulfides, and SH-containing materials such as but not limited to polythiols; and materials having both hydroxyl and thiol functional groups.

Suitable hydroxyl-containing materials for use in the present invention can include a wide variety of materials known in the art. Non-limiting examples can include but are not limited to polyether polyols, polyester polyols, polycaprolactone polyols, polycarbonate polyols, polyurethane polyols, poly vinyl alcohols, polymers containing hydroxy functional acrylates, polymers containing hydroxy functional methacrylates, polymers containing allyl alcohols and mixtures thereof.

Polyether polyols and methods for their preparation are known to one skilled in the art. Many polyether polyols of various types and molecular weight are commercially available from various manufacturers. Non-limiting examples of polyether polyols can include but are not limited to polyoxyalkylene polyols, and polyalkoxylated polyols. Polyoxyalkylene polyols can be prepared in accordance with known methods. In a non-limiting embodiment, a polyoxyalkylene polyol can be prepared by condensing an alkylene oxide, or a mixture of alkylene oxides, using acid- or base-catalyzed addition with a polyhydric initiator or a mixture of polyhydric initiators, such as but not limited to ethylene glycol, propylene glycol, glycerol, and sorbitol. Non-limiting examples of alkylene oxides can include ethylene oxide, propylene oxide, butylene oxide, amylene oxide, aralkylene oxides, such as but not limited to styrene oxide, mixtures of ethylene oxide and propylene oxide. In a further non-limiting embodiment, polyoxyalkylene polyols can be prepared with mixtures of alkylene oxide using random or step-wise oxyalkylation. Non-limiting examples of such polyoxyalkylene polyols include polyoxyethylene, such as but not limited to polyethylene glycol, polyoxypropylene, such as but not limited to polypropylene glycol.

In a non-limiting embodiment, polyalkoxylated polyols can be represented by the following general formula: 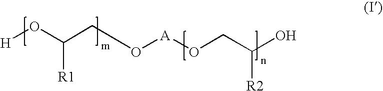
wherein m and n can each be a positive integer, the sum of m and n being from 5 to 70; R₁ and R₂ are each hydrogen, methyl or ethyl; and A is a divalent linking group such as a straight or branched chain alkylene which can contain from 1 to 8 carbon atoms, phenylene, and C₁ to C₉ alkyl-substituted phenylene. The chosen values of m and n can, in combination with the chosen divalent linking group, determine the molecular weight of the polyol. Polyalkoxylated polyols can be prepared by methods that are known in the art. In a non-limiting embodiment, a polyol such as 4,4′-isopropylidenediphenol can be reacted with an oxirane-containing material such as but not limited to ethylene oxide, propylene oxide and butylene oxide, to form what is commonly referred to as an ethoxylated, propoxylated or butoxylated polyol having hydroxyl functionality. Non-limiting examples of polyols suitable for use in preparing polyalkoxylated polyols can include those polyols described in U.S. Pat. No. 6,187,444 B1 at column 10, lines 1-20, which disclosure is incorporated herein by reference.

As used herein and the claims, the term “polyether polyols” can include the generally known poly(oxytetramethylene) diols prepared by the polymerization of tetrahydrofuran in the presence of Lewis acid catalysts such as but not limited to boron trifluoride, tin (IV) chloride and sulfonyl chloride. Also included are the polyethers prepared by the copolymerization of cyclic ethers such as but not limited to ethylene oxide, propylene oxide, trimethylene oxide, and tetrahydrofuran with aliphatic diols such as but not limited to ethylene glycol, 1,3-butanediol, 1,4-butanediol, diethylene glycol, dipropylene glycol, 1,2-propylene glycol and 1,3-propylene glycol. Compatible mixtures of polyether polyols can also be used. As used herein, “compatible” means that two or more materials are mutually soluble in each other so as to essentially form a single phase.

A variety of polyester polyols for use in the present invention are known in the art. Suitable polyester polyols can include but are not limited to polyester glycols. Polyester glycols for use in the present invention can include the esterification products of one or more dicarboxylic acids having from four to ten carbon atoms, such as but not limited to adipic, succinic or sebacic acids, with one or more low molecular weight glycols having from two to ten carbon atoms, such as but not limited to ethylene glycol, propylene glycol, diethylene glycol, 1,4-butanediol, neopentyl glycol, 1,6-hexanediol and 1,10-decanediol. Esterification procedures for producing polyester polyols is described, for example, in the article D. M. Young, F. Hostettler et al., “Polyesters from Lactone,” Union Carbide F-40, p. 147.

In a non-limiting embodiment, the polyol for use in the present invention can include polycaprolactone polyols. Suitable polycaprolactone polyols are varied and known in the art. In a non-limiting embodiment, polycaprolactone polyols can be prepared by condensing caprolactone in the presence of difunctional active hydrogen material such as but not limited to water or low molecular weight glycols such as but not limited to ethylene glycol and propylene glycol. Non-limiting examples of suitable polycaprolactone polyols can include commercially available materials designated as the CAPA series from Solvay Chemical which includes but is not limited to CAPA 2047A, and the TONE series from Dow Chemical such as but not limited to TONE 0201.

Polycarbonate polyols for use in the present invention are varied and known to one skilled in the art. Suitable polycarbonate polyols can include those commercially available (such as but not limited to Ravecarb™ 107 from Enichem S.p.A.). In a non-limiting embodiment, the polycarbonate polyol can be produced by reacting diol, such as described herein, and a dialkyl carbonate, such as described in U.S. Pat. No. 4,160,853. In a non-limiting embodiment, the polyol can include polyhexamethyl carbonate such as HO—(CH₂)₆-[O—C(O)—O— (CH₂)₆]ₙ—OH, wherein n is an integer from 4 to 24, or from 4 to 10, or from 5 to 7.

Further non-limiting examples of hydrogen-containing materials can include low molecular weight di-functional and higher functional polyols and mixtures thereof. In a non-limiting embodiment, these low molecular weight materials can have a number average molecular weight of less than 500 grams/mole. In a further non-limiting embodiment, the amount of low molecular weight material chosen can be such to avoid a high degree of cross-linking in the polyurethane. The di-functional polyols typically contain from 2 to 16, or from 2 to 6, or from 2 to 10, carbon atoms. Non-limiting examples of such difunctional polyols can include but are not limited to ethylene glycol, propylene glycol, diethylene glycol, triethylene glycol, tetraethylene glycol, dipropylene glycol, tripropylene glycol, 1,2-, 1,3- and 1,4-butanediol, 2,2,4-trimethyl-1,3-pentanediol, 2-methyl-1,3-pentanediol, 1,3-2,4- and 1,5-pentanediol, 2,5- and 1,6-hexanediol, 2,4-heptanediol, 2-ethyl-1,3-hexanediol, 2,2-dimethyl-1,3-propanediol, 1,8-octanediol, 1,9-nonanediol, 1,10-decanediol, 1,4-cyclohexanediol, 1,4-cyclohexanedimethanol, 1,2-bis(hydroxyethyl)-cyclohexane and mixtures thereof. Non-limiting examples of trifunctional or tetrafunctional polyols can include glycerin, tetramethylolmethane, such as but not limited to pentaerythritol, trimethylolethane and trimethylolpropane; and mixtures thereof.

Non-limiting examples of suitable polyols for use in the present invention can include straight or branched chain alkane polyols, such as but not limited to 1,2-ethanediol, 1,3-propanediol, 1,2-propanediol, 1,4-butanediol, 1,3-butanediol, glycerol, neopentyl glycol, trimethylolethane, trimethylolpropane, di-trimethylolpropane, erythritol, pentaerythritol and di-pentaerythritol; polyalkylene glycols, such as but not limited to diethylene glycol, dipropylene glycol and higher polyalkylene glycols such as but not limited to polyethylene glycols which can have number average molecular weights of from 200 grams/mole to 2,000 grams/mole; cyclic alkane polyols, such as but not limited to cyclopentanediol, cyclohexanediol, cyclohexanetriol, cyclohexanedimethanol, hydroxypropylcyclohexanol and cyclohexanediethanol; aromatic polyols, such as but not limited to dihydroxybenzene, benzenetriol, hydroxybenzyl alcohol and dihydroxytoluene; bisphenols, such as, 4,4′-isopropylidenediphenol; 4,4′-oxybisphenol, 4,4′-dihydroxybenzophenone, 4,4′-thiobisphenol, phenolphthlalein, bis(4-hydroxyphenyl)methane, 4,4′-(1,2-ethenediyl)bisphenol and 4,4′-sulfonylbisphenol; halogenated bisphenols, such as but not limited to 4,4′-isopropylidenebis(2,6-dibromophenol), 4,4′-isopropylidenebis(2,6-dichlorophenol) and 4,4′-isopropylidenebis(2,3,5,6-tetrachlorophenol); alkoxylated bisphenols, such as but not limited to alkoxylated 4,4′-isopropylidenediphenol which can have from 1 to 70 alkoxy groups, for example, ethoxy, propoxy, α-butoxy and β-butoxy groups; and biscyclohexanols, which can be prepared by hydrogenating the corresponding bisphenols, such as but not limited to 4,4′-isopropylidene-biscyclohexanol, 4,4′-oxybiscyclohexanol, 4,4′-thiobiscyclohexanol and bis(4-hydroxycyclohexanol)methane and mixtures thereof.

Further non-limiting examples of polyols for use in the present invention can include glycerol; trimethylolethane, such as but not limited to 1,1,1-trimethylolethane; trimethylolpropane, such as but not limited to 1,1,1-trimethylolpropane; benzenetriol, such as but not limited to 1,2,3-benzenetriol, 1,2,4-benzenetriol, and 1,3,5-benzenetriol; cyclohexanetriol, such as but not limited to 1,3,5-cyclohexanetriol; erythritol; pentaerythritol; sorbitol; mannitol; sorbitan; dipentaerythritol; tripentaerythritol or mixtures thereof.

Further non-limiting examples of such suitable polyols for use in the present invention can include the aforementioned polyols which can be ethoxylated, propoxylated and butoxylated. In alternate non-limiting embodiments, the following polyols can be alkoxylated with from 1 to 50 alkoxy groups: glycerol, trimethylolethane, trimethylolpropane, benzenetriol, cyclohexanetriol, erythritol, pentaerythritol, sorbitol, mannitol, sorbitan, dipentaerythritol and tripentaerythritol. In alternate non-limiting embodiments, alkoxylated, ethoxylated and propoxylated polyols and mixtures thereof can be used alone or in combination with unalkoxylated, unethoxylated and unpropoxylated polyols having at least three hydroxyl groups and mixtures thereof. The number of alkoxy groups can be from 1 to 50, or from 2 to 20 or any rational number between 1 and 50. In a non-limiting embodiment, the alkoxy group can be ethoxy and the number of ethoxy groups can be 2.5 to 20 units. In another non-limiting embodiment, polyol can be trimethylolpropane having 20 ethoxy groups.

In a further non-limiting embodiment, the polyol can be polyurethane prepolymer. Such polyurethane prepolymer can be prepared by combining the above-listed polyols with the aforementioned isocyanates.

In a non-limiting embodiment, the active hydrogen-containing material for use in the present invention can include sulfur-containing materials such as SH-containing materials, such as but not limited to polythiols having at least two thiol groups. Non-limiting examples of suitable polythiols can include but are not limited to aliphatic polythiols, cycloaliphatic polythiols, aromatic polythiols, heterocyclic polythiols, polymeric polythiols, oligomeric polythiols and mixtures thereof. The sulfur-containing active hydrogen-containing material can have linkages including but not limited to ether linkages (—O—), sulfide linkages (—S—), polysulfide linkages (—Sₓ—, wherein x is at least 2, or from 2 to 4) and combinations of such linkages. As used herein and the claims, the terms “thiol,” “thiol group,” “mercapto” or “mercapto group” refer to an —SH group which is capable of forming a thiourethane linkage, (i.e., —NH—C(O)—S—) with an isocyanate group or a dithioruethane linkage (i.e., —NH—C(S)—S—) with an isothiocyanate group.

Non-limiting examples of suitable polythiols can include but are not limited to 2,5-dimercaptomethyl-1,4-dithiane, dimercaptoethylsulfide, pentaerythritol tetrakis(3-mercaptopropionate), pentaerythritol tetrakis(2-mercaptoacetate), trimethylolpropane tris(3-mercaptopropionate), trimethylolpropane tris(2-mercaptoacetate), 4-mercaptomethyl-3,6-dithia-1,8-octanedithiol, 4-tert-butyl-1,2-benzenedithiol, 4,4′-thiodibenzenethiol, ethanedithiol, benzenedithiol, ethylene glycol di(2-mercaptoacetate), ethylene glycol di(3-mercaptopropionate), poly(ethylene glycol) di(2-mercaptoacetate) and poly(ethylene glycol) di(3-mercaptopropionate), and mixtures thereof.

Suitable amines for use in the present invention are numerous and widely varied. Non-limiting examples can include but are not limited to aliphatic amines, cycloaliphatic amines, aromatic amines and mixtures thereof. In alternate non-limiting embodiments, the amine can be a polyamine having at least two functional groups independently chosen from primary amine (—NH₂), secondary amine (—NH—) and combinations thereof. In a further non-limiting embodiment, the amine can have at least two primary amine groups. In another non-limiting embodiment, the amine can comprise a diamine and optionally polyamine and/or at least one material selected from a polythiol and polyol. Non-limiting examples of suitable polythiols and polyols include those previously recited herein. In still another non-limiting embodiment, the amine can be a sulfur-containing amine material. A non-limiting example of a sulfur-containing amine material can include Ethacure 300 which is commercially available from Albemarle Corporation.

In an embodiment wherein it is desirable to produce polyurethane(ureas) and sulfur-containing polyurethane(ureas) having low color, the amine can be chosen such that it has relatively low color and/or it can be manufactured and/or stored in a manner as to prevent the amine from developing color (e.g., yellow).

Suitable amines for use in the present invention can include but are not limited to materials having the following chemical formula: 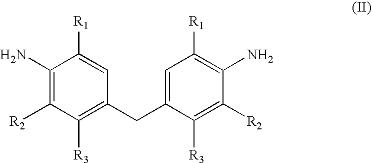
wherein R₁ and R₂ can each be independently chosen from methyl, ethyl, propyl, and isopropyl groups, and R₃ can be chosen from hydrogen and chlorine. Non-limiting examples of diamine-containing curing agents for use in the present invention include the following compounds, manufactured by Lonza Ltd. (Basel, Switzerland):

LONZACURE™. M-DIPA: R₁═C₃H₇; R₂═C₃H₇; R₃═H

LONZACURE™. M-DMA: R₁═CH₃; R₂═CH₃; R₃═H

LONZACURE™. M-MEA: R₁═CH₃; R₂═C₂H₅; R₃═H

LONZACURE™. M-DEA: R₁═C₂H₅; R₂═C₂H₅; R₃═H

LONZACURE™. M-MIPA: R₁═CH₃; R₂═C₃H₇; R₃═H

LONZACURE™. M-CDEA: R₁═C₂H₅; R₂═C₂H₅; R₃=Cl

wherein R₁, R₂ and R₃ correspond to the aforementioned chemical formula.

In a non-limiting embodiment, the amine can include but is not limited to a diamine materials such as 4,4′-methylenebis(3-chloro-2,6-diethylaniline), (Lonzacure™. M-CDEA), which is available in the United States from Air Products and Chemical, Inc. (Allentown, Pa.). In alternate non-limiting embodiments, the amine for use in the present invention can include 2,4-diamino-3,5-diethyl-toluene, 2,6-diamino-3,5-diethyl-toluene and mixtures thereof (collectively “diethyltoluenediamine” or “DETDA”), which is commercially available from Albemarle Corporation under the trade name Ethacure 100; dimethylthiotoluenediamine (DMTDA), which is commercially available from Albemarle Corporation under the trade name Ethacure 300; 4,4′-methylene-bis-(2-chloroaniline) which is commercially available from Kingyorker Chemicals under the trade name MOCA. DETDA can be a liquid at room temperature with a viscosity of 156 cPs at 25° C. DETDA can be isomeric, with the 2,4-isomer range being from 75 to 81 percent while the 2,6-isomer range can be from 18 to 24 percent.

In a non-limiting embodiment, the amine can act as a catalyst in the polymerization reaction and can be incorporated into the resulting polymerizate.

Non-limiting examples of amines can include ethyleneamines. Suitable ethyleneamines can include but are not limited to ethylenediamine (EDA), diethylenetriamine (DETA), triethylenetetramine (TETA), tetraethylenepentamine (TEPA), pentaethylenehexamine (PEHA), piperazine, morpholine, substituted morpholine, piperidine, substituted piperidine, diethylenediamine (DEDA), and 2-amino-1-ethylpiperazine. In alternate non-limiting embodiments, the diamine-containing curing agent can be chosen from one or more isomers of C₁-C₃ dialkyl toluenediamine, such as but not limited to 3,5-dimethyl-2,4-toluenediamine, 3,5-dimethyl-2,6-toluenediamine, 3,5-diethyl-2,4-toluenediamine, 3,5-diethyl-2,6-toluenediamine, 3,5-diisopropyl-2,4-toluenediamine, 3,5-diisopropyl-2,6-toluenediamine, and mixtures thereof. In alternate non-limiting embodiments, the diamine-containing curing agent can be methylene dianiline or trimethyleneglycol di(para-aminobenzoate).

In a non-limiting embodiment, the polyurethane prepolymer can be reacted with amide to form polyurethane polyurea isocyanate prepolymer.

In the present invention, isocyanate, polyol, amine and diol, can be combined together in a one-pot process.

In another embodiment, isocyanate and polyol can be reacted to form polyurethane prepolymer; the polyurethane prepolymer can be reacted with amine to form polyurethane polyurea isocyanate prepolymer; the polyurethane polyurea isocyanate prepolymer then can be chain extended with diol to form polyurethane polyurea polymer. In this embodiment, wherein prepolymer is formed, the isocyanate can be present in an excess amount. In a further non-limiting embodiment, the amount of isocyanate and the amount of polyol present can be such that the equivalent ratio of (NCO:OH) is from 5.0:1.0 to 10.0:1.0. Further, the amount of amine can be such that the amine is from 3 to 20% by weight of the amount of isocyanate present in the mixture.

Suitable diols for use in the present invention are varied and can be include those known in the art, and can be selected from those previously disclosed herein. Non-limiting examples can include aliphatic, cycloaliphatic, aromatic, heterocyclic, polymeric, oligomeric diols and mixtures thereof.

Non-limiting examples of suitable aliphatic diols can include materials described by the following formula:

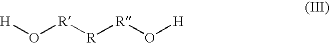

wherein R can represent C₀ to C₃₀ divalent linear or branched aliphatic, cycloaliphatic, aromatic, heterocyclic, or oligomeric saturated alkylene radical or mixtures thereof; C₂ to C₃₀ divalent organic radical containing at least one element selected from the group consisting of sulfur, oxygen and silicon in addition to carbon and hydrogen atoms; C₅ to C₃₀ divalent saturated cycloalkylene radical; C₅ to C₃₀ divalent saturated heterocycloalkylene radical; and

R′ and R″ can each independently represent C₁ to C₃₀ divalent linear or branched aliphatic, cycloaliphatic, aromatic, heterocyclic, polymeric, oligomeric saturated alkylene radical or mixtures thereof.

Non-limiting examples of diols for use in the present invention can include ethylene glycol; propylene glycol; 1,2-butanediol; 1,4-butanediol; 1,3-butanediol; 2,2,4-trimethyl-1,3-pentanediol; 1,5-pentanediol; 2,4-pentanediol; 1,6 hexanediol; 2,5-hexanediol; 3,6-dithia-1,2-octanediol; 1,12-dodecanediol; 1,4-bis(hydroxyethylpiperazine); N,N′,bis(2-hydroxyethyloxamide); 2,2′-thiodiethanol; tetrabromobisphenol-A-bis(2-hydroxyethyl)ether; bis(4-(2-hydroxyethoxy)-3,5-dibromophenyl)sulfone; 1,4-benzenedimethanol; 4,4′-isopropylidene-biscyclohexanol; 2-methyl-butanediol; 2-methyl-1,3 pentanediol; 2,4-heptanediol; 2-ethyl-1,3-hexanediol; 2,2-dimethyl-1,3-propanediol; 1,4-cyclohexanediol; 2,2-dimethyl-3-hydroxypropyl-2,2-dimethyl-3-hydroxypropionate; diethylene glycol; triethylene glycol; tetraethylene glycol; dipropylene glycol; tripropylene glycol; 1,4-cyclohexanedimethanol; 1,2-bis(hydroxymethyl)cyclohexane; 1,2-bis(hydroxyethyl)-cyclohexane; bishydroxypropyl hydantoins; tris hydroxyethyl isocyanurate; the alkoxylation product of 1 mole of 2,2-bis(4-hydroxyphenyl)propane (i.e., bisphenol-A) and 2 moles of propylene oxide; and mixtures thereof.

In another non-limiting embodiment, isocyanate and polyol can be reacted to form polyurethane prepolymer; the polyurethane prepolymer can be reacted with amine to form polyurethane polyurea isocyanate prepolymer; and the polyurethane polyurea isocyanate prepolymer can be chain extended with diol to form polyurethane poly(urea). In this embodiment, the diol can be diol having C₂-C₁₂ carbon chain. In another non-limiting embodiment, the isocyanate, polyol, amine and diol can be combined together in a one pot process to form polyurethane polyurea. In this embodiment, the diol can be diol having C₂-C₁₂ carbon chain.

The polyurethane(urea) of the present invention can be polymerized using a variety of techniques known in the art. In a non-limiting embodiment, the polyurethane(urea) can be prepared by introducing together isocyanate or a mixture of isocyanate and isothiocyanate and polyol or optionally a mixture of polyol and polythiol to form polyurethane prepolymer; the polyurethane prepolymer can be combined with amine or a mixture of amine and polyol and/or polythiol to form polyurethane polyurea isocyanate prepolymer; and the polyurethane polyurea isocyanate prepolymer can be combined with diol or optionally a mixture of diol and dithiol, and optionally catalyst, to form polyurethane polyurea. The polyurethane polyurea can be polymerized. In a non-limiting embodiment, the aforementioned ingredients each can be degassed. In another non-limiting embodiment, the prepolymer can be degassed, the difunctional material can be degassed, and then these two materials can be combined.

In another non-limiting embodiment, the polyurethane(urea) can be prepared by a one-pot process; the polyurethane(ura) can be polymerized by introducing together the isocyanate or optionally a mixture of isocyanate and isothiocyanate, polyol or optionally a mixture of polyol and polythiol, amine or optionally a mixture of amine and polyol and/or polythiol, and diol or optionally a mixture of diol and dithiol, and optionally catalyst.

In further non-limiting embodiments, amide can be used instead of amine.

Suitable catalysts can be selected from those known in the art. Non-limiting examples can include but are not limited to tertiary amine catalysts or tin compounds or mixtures thereof. In alternate non-limiting embodiments, the catalysts can be dimethyl cyclohexylamine or dibutyl tin dilaurate or mixtures thereof. In other non-limiting embodiment, the catalyst can be selected from butyl stanoic acid, bismuth carboxylates, zirconium carboxylates and mixtures thereof. In further non-limiting embodiments, degassing can take place prior to or following addition of catalyst.

In another non-limiting embodiment, wherein a window can be formed, the mixture which can be optionally degassed can be introduced into a mold and the mold can be heated (i.e., thermal cure cycle) using a variety of conventional techniques known in the art. The thermal cure cycle can vary depending on the reactivity and molar ratio of the reactants. In a non-limiting embodiment, the thermal cure cycle can include heating the mixture of prepolymer and diol or optionally mixture of diol and dithiol; or heating the mixture of isocyanate, polyol and/or polythiol, amine and diol or mixture of diol and dithiol, from room temperature to a temperature of 200° C. over a period of from 0.5 hours to 72 hours; or from 80 to 150° C. for a period of from 5 hours to 48 hours.

In a non-limiting embodiment, a urethane-forming catalyst can be used in the present invention to enhance the reaction of the polyurethane-forming materials. Suitable urethane-forming catalysts can vary, for example, suitable urethane-forming catalysts can include those catalysts that are useful for the formation of urethane by reaction of the NCO and OH-containing materials, and which have little tendency to accelerate side reactions leading to allophonate and isocyanate formation. Non-limiting examples of suitable catalysts can be chosen from the group of Lewis bases, Lewis acids and insertion catalysts as described in Ullmann's Encyclopedia of Industrial Chemistry, 5^{th} Edition, 1992, Volume A21, pp. 673 to 674. In a non-limiting embodiment, the catalyst can be a stannous salt of an organic acid, such as but not limited to stannous octoate, dibutyl tin dilaurate, dibutyl tin diacetate, dibutyl tin mercaptide, dibutyl tin dimaleate, dimethyl tin diacetate, dimethyl tin dilaurate, 1,4-diazabicyclo[2.2.2]octane, and mixtures thereof. In alternate non-limiting embodiments, the catalyst can be zinc octoate, bismuth, or ferric acetylacetonate.

Further non-limiting examples of suitable catalysts can include tin compounds such as but not limited to dibutyl tin dilaurate, phosphines, tertiary ammonium salts and mixtures thereof.

In alternate non-limiting embodiments, various known additives can be incorporated into the polyurethane of the present invention. Such additives can include but are not limited to light stabilizers, heat stabilizers, antioxidants, fire retardants, ultraviolet light absorbers, mold release agents, static (non-photochromic) dyes, pigments and flexibilizing additives, such as but not limited to alkoxylated phenol benzoates and poly(alkylene glycol) dibenzoates. Non-limiting examples of anti-yellowing additives can include 3-methyl-2-butenol, organo pyrocarbonates and triphenyl phosphite (CAS registry no. 101-02-0). Such additives can be present in an amount such that the additive constitutes less than 30 percent by weight, or less than 15 percent by weight, or less than 3 percent by weight, based on the total weight of the polymer. In alternate non-limiting embodiments, the aforementioned optional additives can be mixed with the polyisocyanate. In a further embodiment, the optional additives can be mixed with polyol.

In a non-limiting embodiment, the resulting polyurethane(urea) of the present invention when cured can be solid, and essentially transparent such that it is suitable for optical or ophthalmic applications. In a non-limiting embodiment, the polyurethane can be cured such that essentially no further reaction occurs.

In a non-limiting embodiment, the polyurethane(urea) when polymerized and cured can demonstrate good impact resistance/strength. Impact resistance can be measured using a variety of conventional methods known to one skilled in the art. In a non-limiting embodiment, the impact resistance is measured using the Gardner Impact Test in accordance with ASTM-D 5420-04, which consists of a 40-inch aluminum tube in which an 8- or 16-lb weight is dropped from various heights onto a metal dart resting on the substrate being tested. In a further non-limiting embodiment, the impact results of the Gardner Impact Test can be from 65 in-lb to 640 in-lb.

In another non-limiting embodiment, the Dynatup Test in accordance with ASTM-D 638-03 can be conducted which consists of high velocity test with a load cell which measures total energy absorption in the first microseconds of the impact. The impact strength can be measured in joules. In alternate non-limiting embodiments, the substrate can have an impact strength of from 35 to 105 joules.

Abrasion resistance of the polyurethane(urea) can be measured using a Taber Abrater wherein 100 cycles of Taber can result in 30% haze for stretched acrylic and from 5% to 40%, or from 10% to 15% for the polyurethane. Further, Stress Craze Test to solvents in acids can be conducted on the polyurethane(urea) of the present invention. The polyurethane(urea) when uncoated can withstand 75% sulfuric acid up to thirty days or any organic solvent at from 1000 to 4000 psi membrane stress.

In a non-limiting embodiment, the polyurethane(urea) of the present invention when cured can have low density. In a non-limiting embodiment, the density can be from greater than 0.9 to less than 1.25 grams/cm³, or from greater than 1.0 to less than 1.45 grams/cm³, or from 1.09 to 1.3 grams/cm³ In a non-limiting embodiment, the density is measured using a DensiTECH instrument manufactured by Tech Pro, Incorporated. In a further non-limiting embodiment, the density is measured in accordance with ASTM-D 297.

Solid articles that can be prepared using the polyurethane(urea) of the present invention include but are not limited to optical lenses, windows, automotive transparencies, such as windshields, sidelights and backlights, and aircraft transparencies.

In a non-limiting embodiment, the polyurethane(urea)polymerizate of the present invention can be used to prepare photochromic articles. In a further embodiment, the polymerizate can be transparent to that portion of the electromagnetic spectrum which activates the photochromic substance(s), i.e., that wavelength of ultraviolet (UV) light that produces the colored or open form of the photochromic substance and that portion of the visible spectrum that includes the absorption maximum wavelength of the photochromic substance in its UV activated form, i.e., the open form.

A wide variety of photochromic substances can be used in the present invention. In a non-limiting embodiment, organic photochromic compounds or substances can be used. In alternate non-limiting embodiments, the photochromic substance can be incorporated, e.g., dissolved, dispersed or diffused into the polymerizate, or applied as a coating thereto.

In a non-limiting embodiment, the organic photochromic substance can have an activated absorption maximum within the visible range of greater than 590 nanometers. In a further non-limiting embodiment, the activated absorption maximum within the visible range can be between greater than 590 to 700 nanometers. These materials can exhibit a blue, bluish-green, or bluish-purple color when exposed to ultraviolet light in an appropriate solvent or matrix. Non-limiting examples of such substances that are useful in the present invention include but are not limited to spiro(indoline)naphthoxazines and spiro(indoline)benzoxazines. These and other suitable photochromic substances are described in U.S. Pat. Nos. 3,562,172; 3,578,602; 4,215,010; 4,342,668; 5,405,958; 4,637,698; 4,931,219; 4,816,584; 4,880,667; 4,818,096.

In another non-limiting embodiment, the organic photochromic substances can have at least one absorption maximum within the visible range of between 400 and less than 500 nanometers. In a further non-limiting embodiment, the substance can have two absorption maxima within this visible range. These materials can exhibit a yellow-orange color when exposed to ultraviolet light in an appropriate solvent or matrix. Non-limiting examples of such materials can include certain chromenes, such as but not limited to benzopyrans and naphthopyrans. Many of such chromenes are described in U.S. Pat. Nos. 3,567,605; 4,826,977; 5,066,818; 4,826,977; 5,066,818; 5,466,398; 5,384,077; 5,238,931; and 5,274,132.

In another non-limiting embodiment, the photochromic substance can have an absorption maximum within the visible range of between 400 to 500 nanometers and an absorption maximum within the visible range of between 500 to 700 nanometers. These materials can exhibit color(s) ranging from yellow/brown to purple/gray when exposed to ultraviolet light in an appropriate solvent or matrix. Non-limiting examples of these substances can include certain benzopyran compounds having substituents at the 2-position of the pyran ring and a substituted or unsubstituted heterocyclic ring, such as a benzothieno or benzofurano ring fused to the benzene portion of the benzopyran. Further non-limiting examples of such materials are disclosed in U.S. Pat. No. 5,429,774.

In a non-limiting embodiment, the photochromic substance for use in the present invention can include photochromic organo-metal dithizonates, such as but not limited to (arylazo)-thioformic arylhydrazidates, such as but not limited to mercury dithizonates which are described, for example, in U.S. Pat. No. 3,361,706. Fulgides and fulgimides, such as but not limited to 3-furyl and 3-thienyl fulgides and fulgimides which are described in U.S. Pat. No. 4,931,220 at column 20, line 5 through column 21, line 38, can be used in the present invention.

The relevant portions of the aforedescribed patents are incorporated herein by reference.

In alternate non-limiting embodiments, the photochromic articles of the present invention can include one photochromic substance or a mixture of more than one photochromic substances. In further alternate non-limiting embodiment, various mixtures of photochromic substances can be used to attain activated colors such as a near neutral gray or brown.

The amount of photochromic substance employed can vary. In alternate non-limiting embodiments, the amount of photochromic substance and the ratio of substances (for example, when mixtures are used) can be such that the polymerizate to which the substance is applied or in which it is incorporated exhibits a desired resultant color, e.g., a substantially neutral color such as shades of gray or brown when activated with unfiltered sunlight, i.e., as near a neutral color as possible given the colors of the activated photochromic substances. In a non-limiting embodiment, the amount of photochromic substance used can depend upon the intensity of the color of the activated species and the ultimate color desired.

In alternate non-limiting embodiments, the photochromic substance can be applied to or incorporated into the polymerizate by various methods known in the art. In a non-limiting embodiment, the photochromic substance can be dissolved or dispersed within the polymerizate. In a further non-limiting embodiment, the photochromic substance can be imbibed into the polymerizate by methods known in the art. The term “imbibition” or “imbibe” includes permeation of the photochromic substance alone into the polymerizate, solvent assisted transfer absorption of the photochromic substance into a porous polymer, vapor phase transfer, and other such transfer mechanisms. In a non-limiting embodiment, the imbibing method can include coating the photochromic article with the photochromic substance; heating the surface of the photochromic article; and removing the residual coating from the surface of the photochromic article. In alternate non-limiting embodiments, the imbibtion process can include immersing the polymerizate in a hot solution of the photochromic substance or by thermal transfer.

In alternate non-limiting embodiments, the photochromic substance can be a separate layer between adjacent layers of the polymerizate, e.g., as a part of a polymer film; or the photochromic substance can be applied as a coating or as part of a coating placed on the surface of the polymerizate.

The amount of photochromic substance or composition containing the same applied to or incorporated into the polymerizate can vary. In a non-limiting embodiment, the amount can be such that a photochromic effect discernible to the naked eye upon activation is produced. Such an amount can be described in general as a photochromic amount. In alternate non-limiting embodiments, the amount used can depend upon the intensity of color desired upon irradiation thereof and the method used to incorporate or apply the photochromic substance. In general, the more photochromic substance applied or incorporated, the greater the color intensity. In a non-limiting embodiment, the amount of photochromic substance incorporated into or applied onto a photochromic optical polymerizate can be from 0.15 to 0.35 milligrams per square centimeter of surface to which the photochromic substance is incorporated or applied.

In another embodiment, the photochromic substance can be added to the polyurethane prior to polymerizing and/or cast curing the material. In this embodiment, the photochromic substance used can be chosen such that it is resistant to potentially adverse interactions with, for example, the isocyanate present. Such adverse interactions can result in deactivation of the photochromic substance, for example, by trapping them in either an open or closed form.

Further non-limiting examples of suitable photochromic substances for use in the present invention can include photochromic pigments and organic photochromic substances encapsulated in metal oxides such as those disclosed in U.S. Pat. Nos. 4,166,043 and 4,367,170; organic photochromic substances encapsulated in an organic polymerizate such as those disclosed in U.S. Pat. No. 4,931,220.

We claim:

1. Polyurethane(urea) comprising the reaction product of isocyanate, polyol, amine and C₂ to C₁₂ diol.

2. The polyurethane(urea) of claim 1 prepared by:
(a) reacting said isocyanate and said polyol to form polyurethane prepolymer;
(b) reacting said polyurethane prepolymer and said amine to form polyurethane polyurea isocyanate prepolymer; and
(c) reacting said polyurethane polyurea isocyanate prepolymer with said diol to form said polyurethane(urea).

3. The polyurethane(urea) of claim 2 wherein the equivalent ratio of NCO:OH if from 5.0:1.0 to 10.0:1.0.

4. The polyurethane(urea) of claim 1 prepared by reacting said isocyanate, said polyol, said amine and said diol in a one pot process.

5. The polyurethane(urea) of claim 1 wherein said isocyanate is chosen from monomeric isocyanates, polymeric isocyanates and mixtures thereof.

6. The polyurethane(urea) of claim 1 wherein said isocyanate is chosen from aliphatic isocyanates, cycloaliphatic isocyanates, aromatic isocyanates, and mixtures thereof.

7. The polyurethane(urea) of claim 1 wherein said polyol is chosen from polyether polyols, polyester polyols, polycaprolactone polyols, polycarbonate polyols, polyurethane polyols, poly vinyl alcohols, polymers containing hydroxy functional acrylates, polymers containing hydroxy functional methacrylates, polymers containing allyl alcohols and mixtures thereof.

8. The polyurethane(urea) of claim 1 wherein said amine is chosen from aliphatic amines, cycloaliphatic amines, aromatic amines and mixtures thereof.

9. The polyurethane(urea) of claim 1 wherein said amine is chosen from primary amine, secondary amine or mixtures thereof.

10. The polyurethane of claim 1 wherein said diol is chosen from 1,2-butanediol; 1,4-butanediol; 1,3-butanediol; 2,2,4-trimethyl-1,3-pentanediol; 1,5-pentanediol; 2,4-pentanediol; 1,6 hexanediol; 2,5-hexanediol; 3,6-dithia-1,2-octanediol; 1,12-dodecanediol; 1,4-bis(hydroxyethylpiperazine); N,N′,bis(2-hydroxyethyloxamide); 2,2′-thiodiethanol; tetrabromobisphenol-A-bis(2-hydroxyethyl)ether; bis(4-(2-hydroxyethoxy)-3,5-dibromophenyl)sulfone; 1,4-benzenedimethanol; 4,4′-isopropylidene-biscyclohexanol; 2-methyl-butanediol; and mixtures thereof.

11. The polyurethane(urea) of claim 1 adapted to have a Gardner Impact strength of from 65 in-lb to 640 in-lb.

12. The polyurethane(urea) of claim 1 adapted to have a Dynatup impact strength of from 35 joules to 105 joules.

13. The polyurethane(urea) of claim 1 adapted to have an abrasion resistance wherein 100 cycles of Taber results in from 5% to 40% haze.

14. The polyurethane(urea) of claim 1 adapted to have a stress craze wherein said polyurethane uncoated can withstand organic solvent from 1000 psi to 4000 psi membrane stress.

15. The polyurethane(urea) of claim 2 wherein the equivalent ratio of said isocyanate to said polyol is 5.0:1.0.

16. The polyurethane(urea) of claim 2 wherein said amine is present in an amount of from 3% to 20% by weight based on said isocyanate.

17. Polyurethane(urea) comprising the reaction product of isocyanate, polyol, amine and diol adapted to have a Gardner impact strength of from 65 in-lb to 640 in-lb.

18. Polyurethane(urea) comprising the reaction product of isocyanate, polyol, amine and diol adapted to have a Duniatup impact strength of from 35 joules to 105 joules.

19. Polyurethane(urea) comprising the reaction product of isocyanate, polyol, amine and diol adapted to have an abrastion resistance wherein 100 cycles of Taber results in from 5% to 40% haze.

20. Polyurethane(urea) comprising the reaction product of isocyanate, polyol, amine and diol adapted to have a stress craze said polyurethane uncoated can withstand organic solvent from 1000 psi to 4000 psi membrane stress.

21. Sulfur-containing polyurethane(urea) comprising material chosen from isocyanate, isothiocyanate, and mixtures thereof; material chosen from polyol, polythiol and mixtures thereof; at least one of amine or mixture of amine and polyol and/or polythiol; and at least one of dithiol or a mixture of dithiol and diol adapted to have a Gardner impact strength of from 65 in-lb to 640 in-lb.

22. A method of preparing polyurethane(urea) comprising:
(a) reacting isocyanate and polyol to form polyurethane prepolymer;
(b) reacting said polyurethane prepolymer and amine to form polyurethane polyurea isocyanate prepolymer; and
(c) reacting said polyurethane polyurea isocyanate prepolymer with C₂-C₁₂ diol to form said polyurethane(urea).

23. The method of claim 22 wherein the NCO:OH equivalent ratio in (a) is from 5.0:1.0 to 10.0:1.0.

24. The method of claim 22 wherein said amine in (b) is present in an amount such that it constitutes from 3 to 20% by weight based on said isocyanate.

25. A method of preparing polyurethane(urea) comprising reacting isocyanate, polyol, amine and C₂-C₁₂ diol in one-pot.

26. Sulfur-containing polyurethane(urea) comprising the reaction product of: (a) polyisocyanate, polyisothiocyanate or mixtures thereof; (b) polyol, polythiol or mixtures thereof; (c) amine or mixture of amine and polyol and/or polythiol; and (d) C₂-C₁₂ diol, with the proviso that at least one of (a), (b) or (c) is sulfur-containing.

27. Polyurethane(urea) comprising the reaction product of isocyanate, polyol, amide and C₂ to C₁₂ diol.

28. The polyurethane(urea) of claim 27 prepared by:
(a) reacting said isocyanate and said polyol to form polyurethane prepolymer wherein. NCO:OH equivalent ratio is from 5.0:1.0 to 10.0:1.0;
(b) reacting said polyurethane prepolymer and said amide to form polyurethane polyurea isocyanate prepolymer wherein said amide constitutes from 3% to 20% by weight based on said isocyanate; and
(c) reacting said polyurethane polyurea isocyanate prepolymer with said diol to form said polyurethane(urea).

29. A solid article comprising the polyurethane(urea) of claim 1.

30. A photochromic article comprising the polyurethane(urea) of claim 1.
